(19) United States
(12) Patent Application Publication
(10) Pub. No.: US 2024/0043000 A1
(43) Pub. Date: Feb. 8, 2024

(54) TARGET TRAJECTORY COMPUTATION DEVICE, VEHICLE CONTROL DEVICE, AND TARGET TRAJECTORY COMPUTATION METHOD

(71) Applicant: Mitsubishi Electric Corporation, Tokyo (JP)

(72) Inventors: Yusuke MATSUO, Tokyo (JP); Munenori YAMAMOTO, Tokyo (JP); Hiroyuki KOBAYASHI, Tokyo (JP); Shunsuke NAKAJIMA, Tokyo (JP)

(73) Assignee: Mitsubishi Electric Corporation, Tokyo (JP)

(21) Appl. No.: 18/267,221

(22) PCT Filed: Jan. 22, 2021
(86) PCT No.: PCT/JP2021/002159

§ 371 Date: Jun. 14, 2023

(51) Int. Cl. B60W 30/12; B60W 10/20

(52) U.S. Cl. CPC B60W 30/12; B60W 10/20; B60W 2552/53; B60W 2554/4041; B60W 2554/802

(57) ABSTRACT

A target trajectory computation device includes: an in-the-same-path determination unit that determines, on the basis of dividing line information and preceding vehicle information, presence or absence of a preceding vehicle traveling on the same path as a vehicle; and a target-trajectory setting unit that, in a case where a dividing-line-information acquisition unit can acquire dividing line information on only one of a left dividing line and a right dividing line, computes a target trajectory on the basis of the acquired dividing line information on the one dividing line when the in-the-same-path determination unit determines that there is a preceding vehicle traveling on the same path, and omits to compute the target trajectory when it is determined that there is no preceding vehicle traveling on the same path.

### TECHNICAL FIELD

The present disclosure relates to a target trajectory computation device and a target trajectory computation method to generate a target trajectory on which a vehicle is to travel.

### BACKGROUND ART

Conventionally, there are known techniques of generating a target trajectory from lane dividing line information on the basis of information obtained from a camera attached to the front of a vehicle, and of performing steering assistance or automatic steering of turning wheels in such a manner that the vehicle travels following the generated target trajectory (hereinafter, referred to as “lane keeping system”) (see, for example, Patent Literatures 1 and 2).

For example, Patent Literature 1 discloses a technique in which, in a case where the curvature calculated as a road shape on the basis of map information is equal to or less than a threshold, a line passing through a midway position between dividing lines to the left and right of a vehicle is acquired as the target trajectory when both the dividing lines to the left and right of the vehicle can be recognized, and a line passing through a position at a certain distance from the recognized dividing line is acquired as the target trajectory when the dividing line can be recognized to only the left or right of the vehicle.

Patent Literature 2 discloses a technique in which, in a case where it is determined that there is a transition from a state where no lane is present to both left and right of a vehicle to a state where a lane is present to only either the left or the right, a virtual lane is provided on a side where no lane is present and the lane width is set to a preset value.

### CITATION LIST

### Patent Literatures

Patent Literature 1: JP 2020-82772 A

Patent Literature 2: JP 2017-37473 A

### SUMMARY OF INVENTION

### Technical Problem

However, in the technique of Patent Literature 1, in a case where only one of the left and right dividing lines can be recognized, only when the curvature calculated as a road shape on the basis of map information is equal to or less than the threshold, the target trajectory is acquired on the basis of the recognized one dividing line. The technique is based on the premise that there is different information on a road shape different from the dividing line information acquired by a camera. Therefore, there is a problem that the target trajectory cannot be generated in a curve in a case where the different information on a road shape is not acquired. In addition, in a case where only the dividing line information on one of the left and right dividing lines can be acquired, a case where the acquired dividing line information itself is erroneous is not considered. Therefore, there is a possibility that a target trajectory different from the road shape is generated.

In Patent Literature 2, in a case where only one of the left and right dividing lines can be acquired, the other dividing line that cannot be acquired is virtually set on the basis of a predetermined lane width. The technique of Patent Literature 2 does not consider a case where the acquired dividing line information itself is erroneously detected, and therefore may generate a target trajectory different from the road shape.

The present disclosure has been made to solve the above problems, and an object of the present disclosure is to improve the correctness of a target trajectory generated from the acquired dividing line even in a case where only one of the left and right dividing lines can be acquired.

### Solution to Problem

A target trajectory computation device according to the present disclosure includes:
an in-the-same-path determination unit to, on a basis of dividing line information including a position and a shape of at least one of a left dividing line or a right dividing line with respect to a vehicle acquired by a dividing-line-information acquisition unit and preceding vehicle information including a shape and a traveling position of a preceding vehicle traveling ahead of the vehicle acquired by a preceding-vehicle-information acquisition unit, determine presence or absence of a preceding vehicle traveling on a same path as the vehicle, the in-the-same-path determination unit being configured to determine that there is a preceding vehicle traveling on the same path as the vehicle in a case where the preceding vehicle is present within a predetermined range set on a basis of the dividing line information; and
a target-trajectory setting unit to set a target trajectory on which the vehicle is to travel on a basis of the dividing line information and a result of the determination by the in-the-same-path determination unit, the target-trajectory setting unit being configured to, in a case where the dividing-line-information acquisition unit can acquire the dividing line information on only one of the left dividing line and the right dividing line, compute the target trajectory on a basis of the acquired dividing line information on the one dividing line when the in-the-same-path determination unit determines that the preceding vehicle traveling on the same path is present, and omit to compute the target trajectory when the in-the-same-path determination unit determines that the preceding vehicle is not present.

Furthermore, a target trajectory computation method according to the present disclosure includes the steps of:
acquiring, by an in-the-same-path determination unit, dividing line information including a position and a shape of at least one of a left dividing line or a right dividing line with respect to a vehicle from a dividing-line-information acquisition unit;
acquiring, by the in-the-same-path determination unit, preceding vehicle information including a shape and a traveling position of a preceding vehicle traveling ahead of the vehicle from a preceding-vehicle-information acquisition unit;
determining, by the in-the-same-path determination unit, presence or absence of a preceding vehicle traveling on a same path as the vehicle on a basis of the dividing line information and the preceding vehicle information, the in-the-same-path determination unit being configured to determine that there is a preceding vehicle traveling on the same path as the vehicle in a case where the preceding vehicle is present within a predetermined range set on a basis of the dividing line information; and
setting, by a target-trajectory computation unit, a target trajectory on which the vehicle is to travel on a basis of the dividing line information and a result of the determination by the in-the-same-path determination unit, the target-trajectory computation unit being configured to, in a case where the dividing line acquisition unit can acquire the dividing line information on only one of the left dividing line and the right dividing line, compute the target trajectory on a basis of the acquired dividing line information on the one dividing line when the in-the-same-path determination unit determines that the preceding vehicle traveling on the same path is present.

### ADVANTAGEOUS EFFECTS OF INVENTION

According to the target trajectory computation device and the target trajectory computation method of the present disclosure, even in a case where only one of the left and right dividing lines can be acquired, the correctness of the target trajectory generated from the acquired dividing line information on the one dividing line can be improved by using the information on the preceding vehicle traveling on the same path.

### BRIEF DESCRIPTION OF DRAWINGS

FIG. 1 is a diagram illustrating a configuration of a vehicle in which a vehicle control device is incorporated.

FIG. 2 is a block diagram illustrating a configuration of the vehicle control device including a target trajectory computation device of a first embodiment.

FIG. 3 is a flowchart illustrating an operation of the vehicle control device including the target trajectory computation device of the first embodiment.

FIG. 4 is a diagram illustrating relationships of dividing line information and a preceding vehicle position with respect to the vehicle.

FIG. 5 is a flowchart illustrating an operation in step S2 in FIG. 3.

FIG. 6 is a flowchart illustrating an operation in step S3 in FIG. 3.

FIG. 7 is a diagram illustrating an example of a positional relationship of a target trajectory.

FIG. 8 is a flowchart illustrating an operation of a vehicle control device including a target trajectory computation device of a second embodiment.

FIG. 9 is a flowchart illustrating an operation of a vehicle control device including a target trajectory computation device of a third embodiment.

### DESCRIPTION OF EMBODIMENTS

Hereinafter, each embodiment of a target trajectory computation device according to the present disclosure will be described with reference to the drawings. In each embodiment, the same or corresponding parts are denoted by the same reference numerals, and redundant description is omitted.

### First Embodiment

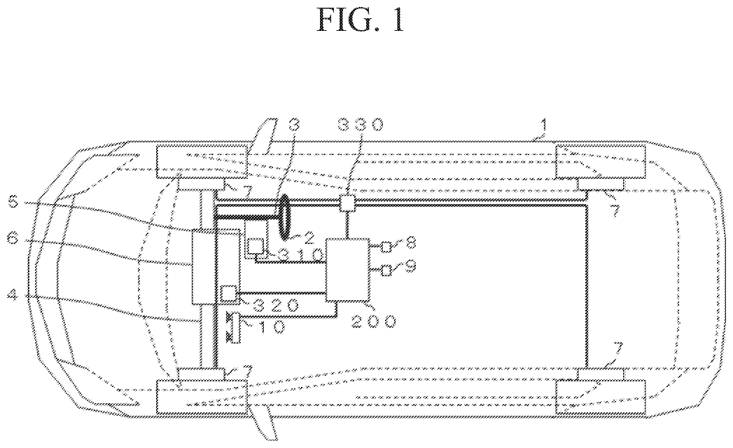

FIG. 1 is a system configuration diagram illustrating a schematic configuration of a vehicle 1 in which a vehicle control device 200 to which a target trajectory computation device of a first embodiment is applied is incorporated. The vehicle control device 200 is, for example, a lane keeping system. In FIG. 1, the vehicle 1 includes a steering wheel 2, a steering shaft 3, a steering unit 4, an electric-power steering unit 5, a powertrain unit 6, a brake unit 7, a yaw rate sensor 8, a vehicle speed sensor 9, a front camera 10, the vehicle control device 200, an electric-power steering controller 310, a powertrain controller 320, and a brake controller 330.

The steering wheel 2 installed for a driver to operate the vehicle 1 is coupled to the steering shaft 3. The steering unit 4 is connected to the steering shaft 3. The steering unit 4 rotatably supports front wheels as steering wheels, and is turnably supported by a vehicle body frame.

The torque generated by the driver operating the steering wheel 2 rotates the steering shaft 3, and the front wheels are turned in a left-right direction by the steering unit 4. As a result, the driver can adjust the lateral movement amount of the vehicle when the vehicle moves forward or backward. The steering shaft 3 can also be rotated by the electric-power steering unit 5, and the front wheels can be freely turned independently of the operation of the steering wheel 2 performed by the driver, by giving an instruction to the electric-power steering controller 310.

The vehicle control device 200 is configured by an integrated circuit such as a microprocessor, and includes an A/D conversion circuit, a D/A conversion circuit, a CPU, a ROM, a RAM, and the like. The yaw rate sensor 111 that detects a yaw rate of the vehicle 1, the vehicle speed sensor 112 that detects a vehicle speed of the vehicle 1, the front camera 121, the electric-power steering controller 310, the powertrain controller 320, and the brake controller 330 are connected to the vehicle control device 200.

Then, the vehicle control device 200 processes the information input from the connected sensors in accordance with the program stored in the ROM, transmits a target control amount to the electric-power steering controller 310, transmits a target driving force to the powertrain controller 320, and transmits a target braking force to the brake controller 330. Note that in a case where the acceleration and deceleration control is not executed by the vehicle control device 200, the powertrain controller 320 and the brake controller 330 do not need to be connected to the vehicle control device 200.

In addition, the front camera 121 is installed at a position where the front camera 121 can detect a dividing line ahead of the vehicle as an image, and detects lane information or information on surrounding objects ahead of the vehicle 1 such as a position of an obstacle on the basis of the image information. Note that, in the present embodiment, an example has been described in which the vehicle 1 includes only the front camera, but the vehicle 1 may include a camera that detects surrounding objects behind or to the side of the vehicle. It may be installed.

In addition, the electric-power steering controller 310 controls the electric-power steering unit 5 on the basis of the target control amount transmitted from the vehicle control device 200. As a result, for example, a lane keeping system function of maintaining a state where the vehicle 1 travels in a portion such as a central portion in a lane is performed.

In addition, the powertrain controller 320 controls the powertrain unit 6 so as to achieve the target driving force transmitted from the vehicle control device 200. Furthermore, in a case where the driver performs the speed control, the powertrain unit 6 is controlled on the basis of an accelerator-pedal stepping amount.

Note that, in the present embodiment, the vehicle using only the engine as the driving power source has been described as an example, but it may be applied to a vehicle using only the electric motor as the driving power source, a vehicle using both the engine and the electric motor as the driving power source, or the like.

Furthermore, the brake controller 330 controls the brake unit 7 so as to achieve the target braking force transmitted from the vehicle control device 200. In addition, in a case where the driver performs the speed control, the brake controller 330 controls the brake unit 7 on the basis of a brake-pedal stepping amount.

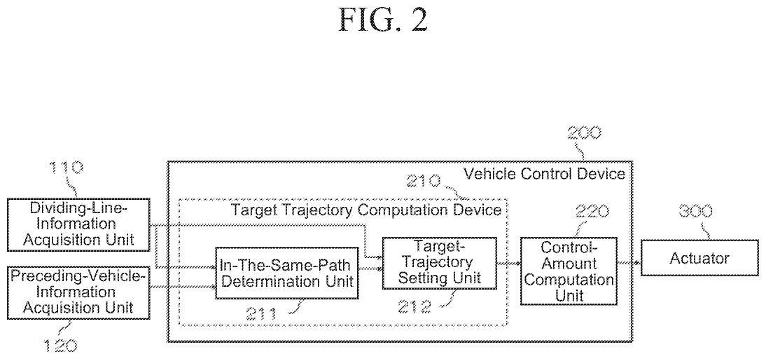

FIG. 2 is a block diagram illustrating a schematic configuration of the vehicle control device 200 including the target trajectory computation device of the first embodiment. A target trajectory computation device 210 according to the first embodiment is provided in the vehicle control device 200. In addition, the vehicle control device 200 includes a dividing-line-information acquisition unit 110, a preceding-vehicle-information acquisition unit 120, and an actuator 300 as peripheral components.

The dividing-line-information acquisition unit 110 is, for example, a camera. The dividing-line-information acquisition unit 110 captures an image of an area ahead of the vehicle, extracts dividing line information using an image processing technique, digitizes the extracted dividing line information, and transmits the digitized dividing line information to the vehicle control device 200. The dividing line information is information on the position and shape of a dividing line ahead of the vehicle 1 based on the position of the vehicle 1 at the time of image capturing. The dividing line information includes, for example, a vehicle dividing line distance that is a distance between the vehicle 1 and a side portion of the dividing line closer to the vehicle 1, a vehicle angle that is an inclination of a traveling direction of the vehicle 1 with respect to the side portion of the dividing line, a curvature of the dividing line, and a curvature change rate of the dividing line. Note that, in the present embodiment, the camera that detects a surrounding object ahead of the vehicle is taken as an example of the dividing-line-information acquisition unit 110, but a camera that detects a surrounding object behind or to the side of the vehicle may be used.

Here, a method of detecting the dividing line information will be described. The dividing-line-information acquisition unit 110 extracts, from the captured image of an area ahead of the vehicle, dividing lines such as white lines located to the left and right of the vehicle 1 in the image by a known method (known technique example: JP 2001-10524 A). Then, the curvature and the curvature change rate of the obtained dividing line are calculated. Hereinafter, a description will be given assuming that the calculated curvature change rate is constant within an image capturing area. In this case, the dividing-line-information acquisition unit 110 calculates, from the curvature at the image capturing position and the curvature change rate, the curvature of the portion ahead of the vehicle 1 in the captured dividing line based on the position of vehicle 1 at the time of image capturing. In addition, the dividing line extended to the position of the vehicle 1 by a known method is estimated by an extrapolation method, and the distance from the position of the vehicle 1 at the time of image capturing to the estimated dividing line is calculated as the vehicle dividing line distance. Furthermore, the inclination of the traveling direction of the vehicle 1 at the time of image capturing with respect to the estimated dividing line is calculated as the vehicle angle.

The preceding-vehicle-information acquisition unit 120 is, for example, a camera. The preceding-vehicle-information acquisition unit 120 captures an image of an area ahead of the vehicle, extracts information on the shape, relative vehicle speed, and relative position of a preceding vehicle based on the vehicle 1 using an image processing technique, digitizes the information, and transmits the digitized information to the vehicle control device 200. The preceding-vehicle-information acquisition unit 120 may include a millimeter wave radar, a laser radar, and the like in addition to the camera, and may be configured to be capable of acquiring the preceding vehicle information from information generated by any one of them or a combination of two or more of them. Note that, it is assumed that the preceding vehicle information can be acquired for a plurality of vehicles. In addition, the preceding-vehicle-information acquisition unit is distinguished from the dividing-line-information acquisition unit 110 in terms of a role, but may be configured to be capable of acquiring information from the same camera.

The vehicle control device 200 is a device that controls a vehicle, and includes a ROM and a RAM that store various programs, and a CPU that executes the programs. For example, the vehicle control device is an advanced driver assistance system electronic control unit (ADAS-ECU). The vehicle control device 200 includes the target trajectory computation device 210 and a control-amount computation unit 220.

The target trajectory computation device 210 computes a target trajectory on the basis of the information acquired from the dividing-line-information acquisition unit 110 and the preceding-vehicle-information acquisition unit 120. The target trajectory is a target value of a trajectory on which the vehicle 1 is to travel when the vehicle control device 200 controls the turning wheels. The target trajectory computation device 210 includes an in-the-same-path determination unit 211 and a target-trajectory setting unit 212.

The in-the-same-path determination unit 211 determines whether the preceding vehicle ahead of the vehicle 1 is traveling on the same path as the vehicle 1 on the basis of the dividing line information acquired by the dividing-line-information acquisition unit 110 and the preceding vehicle information acquired by the preceding-vehicle-information acquisition 120, and outputs the determination result to the target-trajectory setting unit 212.

The target-trajectory setting unit 212 calculates the target trajectory on which the vehicle 1 is to travel on the basis of the dividing line information on the dividing line ahead of the vehicle 1 acquired from the dividing-line-information acquisition unit 110 and the determination result from the in-the-same-path determination unit 211, and outputs the calculation result to the control-amount computation unit 220.

The control-amount computation unit 220 computes a control amount necessary for the vehicle 1 to follow the target trajectory on the basis of the target trajectory set by the target-trajectory generation unit 210, and controls the actuator 300 on the basis of the computation result.

The actuator 300 is, for example, an electric power steering. The steering wheel and the tires are actually moved on the basis of the control amount received from the control-amount computation unit 220.

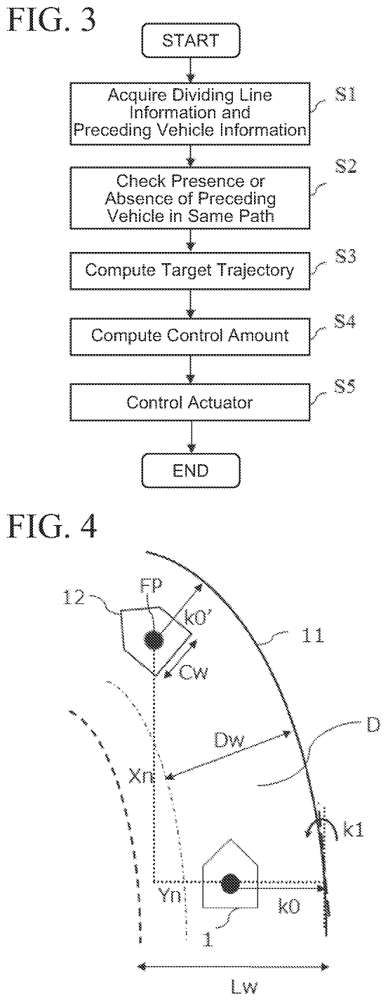

Hereinafter, an actual operation of the vehicle control device 200 will be described in detail. FIG. 3 is a flowchart illustrating an operation of the vehicle control device 200 including the target trajectory computation device 210 according to the first embodiment. The series of operations in FIG. 3 is repeatedly performed with a constant period of, for example, 0.01 seconds. In addition, FIG. 4 is a diagram illustrating relationships of a dividing line 11 and a preceding vehicle 12 with respect to the vehicle 1.

First, in step S1, the dividing-line-information acquisition unit 110 acquires dividing line information on at least one of the left and right dividing lines with respect to the vehicle, and transmits the dividing line information to the in-the-same-path determination unit 211. The dividing-line-information acquisition unit 110 acquires the dividing line information including a vehicle dividing line distance k0, a vehicle angle k1, a curvature k2, and a curvature change rate k3 by using the detection method described above or the like.

In addition, the preceding-vehicle-information acquisition unit 120 detects a preceding vehicle traveling ahead of the vehicle 1, acquires preceding vehicle information including a vehicle shape including a vehicle width, a vehicle speed relative to the vehicle 1, and a relative position with respect to the vehicle 1, and transmits the preceding vehicle information to the in-the-same-path determination unit 211. The relative position of the detected preceding vehicle includes a distance Xn in a longitudinal direction and a distance Yn in a lateral direction as viewed from the vehicle 1, and is represented as FP=[Xn, Yn]. (Here, “n” is a number for identifying each of a plurality of preceding vehicles.) In addition, a function of determining whether it is a preceding vehicle or an obstacle from the vehicle speed relative to the vehicle 1 or the like may be provided.

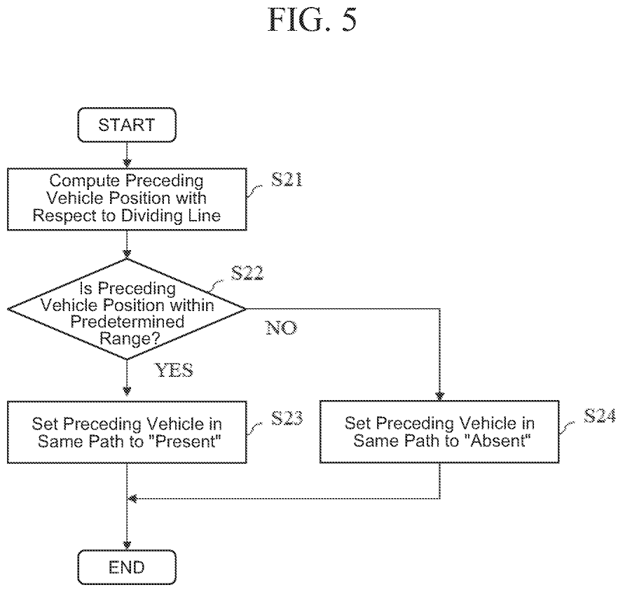

In step S2, on the basis of the dividing line information and the preceding vehicle information acquired in step S1, the in-the-same-path determination unit 211 determines whether the preceding vehicle traveling ahead of the vehicle 1 is traveling within a predetermined range set on the basis of the dividing line information, that is, determines the presence or absence of a preceding vehicle traveling on the same path as the vehicle 1. If there is a preceding vehicle traveling on the same path as the vehicle 1, it can be determined that there is a traveling path at least in an area in which the dividing line is acquired. FIG. 5 is a flowchart illustrating the operation in step S2.

In step S21, the in-the-same-path determination unit 211 calculates a preceding vehicle dividing line distance k0′, which is a distance between the preceding vehicle and the side portion of the dividing line closer to the preceding vehicle, from the dividing line information and the preceding vehicle position acquired in step S1. k0′ is calculated by Equation (1) from the dividing line information including the vehicle dividing line distance k0 of the vehicle 1, the vehicle angle k1, the curvature k2, and the curvature change rate k3, and the preceding vehicle position FP=[Xn, Yn].

$$\begin{matrix}[ Equation 1 ] & \\ k {0}^{′} = \frac{1}{6} \times k 3 \times {Zn}^{3} + \frac{1}{2} \times K 2 \times {Xn}^{2} + k 1 \times Xn + k 0 - Yn & ( 1 )\end{matrix}$$

Strictly speaking, a deviation corresponding to the inclination of the preceding vehicle at the preceding vehicle position FP is generated. However, in a state where the lane keeping system operates, it is assumed that the preceding vehicle and the vehicle 1 travel at a relatively high speed, and thus, in practice, the deviation due to the inclination of the preceding vehicle is hardly generated. Therefore, in order to calculate the preceding vehicle dividing line distance k0′, it is only required to perform a computation using Xn that is the distance in the longitudinal direction between the vehicle 1 and the preceding vehicle position while ignoring the inclination of the preceding vehicle. On the other hand, in a case where the vehicle follows the preceding vehicle in a traffic jam, it is only required to perform a calculation in consideration of the vehicle inclination at the preceding vehicle position FP.

In step S22, the in-the-same-path determination unit 211 determines the presence or absence of a preceding vehicle within a predetermined range D on the basis of the preceding vehicle dividing line distance k0′ calculated in step S21. If there is a preceding vehicle within the predetermined range D from the dividing line, that is, if the absolute value of k0′ is equal to or less than D, the process proceeds to step S23. If there is no preceding vehicle within the predetermined range D, that is, if the absolute value of k0′ is larger than D, the process proceeds to step S24.

Here, the predetermined range D is set to, for example, a range within a distance Dw from one dividing line in the direction of the other dividing line. The distance Dw is determined by Equation (2) on the basis of a width Cw of the preceding vehicle and a distance Lw between the left and right dividing lines.

[Equation 2]

D_{w}=L_{w}−C_{w} (2)

Assuming the distance from the right dividing line, the distance from the right dividing line, which is the boundary value when the preceding vehicle goes over the left dividing line, corresponds to the right side of Equation (2). Therefore, a state in which the preceding vehicle goes over the left dividing line can be detected by setting the predetermined range D to a range within the distance Dw from the right dividing line and checking whether or not the preceding vehicle is within the predetermined range D. Even in a case where the left and right are reversed, it is possible to detect the state of going over the line in the same manner. In a case where the distance between the left and right dividing lines cannot be acquired, for example, in a case where dividing line information on one of the left and right dividing lines cannot be acquired, Lw may be set on the basis of the lane width when both the left and right dividing lines have been acquired in the past, or on the basis of the minimum value of a generally conceivable road width.

In addition, the predetermined range D may be set by determining the type of the preceding vehicle, for example, a two-wheeled vehicle, a towing vehicle, or the like. In the case of the two-wheeled vehicle, the two-wheeled vehicle tends to travel on the side of the traveling path, and thus the predetermined range D may be set large or offset. In the case of the towing vehicle, the towing vehicle may be bent at the coupling portion, and thus a case where the vehicle width or the like cannot be correctly acquired is assumed. Therefore, the determination may be set to be strict by setting the predetermined range D to a small range.

In the above method, the example in which the predetermined range D is set on the basis of the shape of the preceding vehicle and the distance between the left and right dividing lines has been described, but it is not limited thereto. The predetermined range D may be variable depending on a vehicle speed, an inter-vehicle distance, a dividing line shape, and the like. In a case where it is predicted that the error of the preceding vehicle dividing line distance k0′ results in a non-negligible degree, for example, in a case where the inter-vehicle distance is wide or in a case of a road with a strong curve, it is possible to suppress erroneous determination by setting the predetermined range D to be a small range in consideration of the error. On the other hand, it is possible to increase the number of scenes in which control can be continued in the subsequent processing by setting the predetermined range D to be a large range in a road such as an expressway whose lane width is set to be large.

In step S23, the in-the-same-path determination unit 211 sets the preceding vehicle within the predetermined range D set on the basis of the dividing line, that is, in the same path, to “present”.

In step S24, the in-the-same-path determination unit 211 sets the preceding vehicle in the same path to “absent”.

Note that the process in step S2 has been described in detail as the process for one preceding vehicle ahead of the vehicle 1. However, it is not limited thereto, and the similar process may be performed on a plurality of preceding vehicles. If any preceding vehicle is traveling on the same path, the process may proceed to step S23, and if there is no preceding vehicle traveling on the same path, the process may proceed to step S24. As a result, frequent switching of the target preceding vehicle at the time of lane change or cutting in can be suppressed, and the determination of “presence” of the preceding vehicle in the same path can be stably continued as long as the preceding vehicle once determined to be the preceding vehicle in the same path is in the same path. As a result, it can be expected that the opportunity to continue the subsequent processing increases.

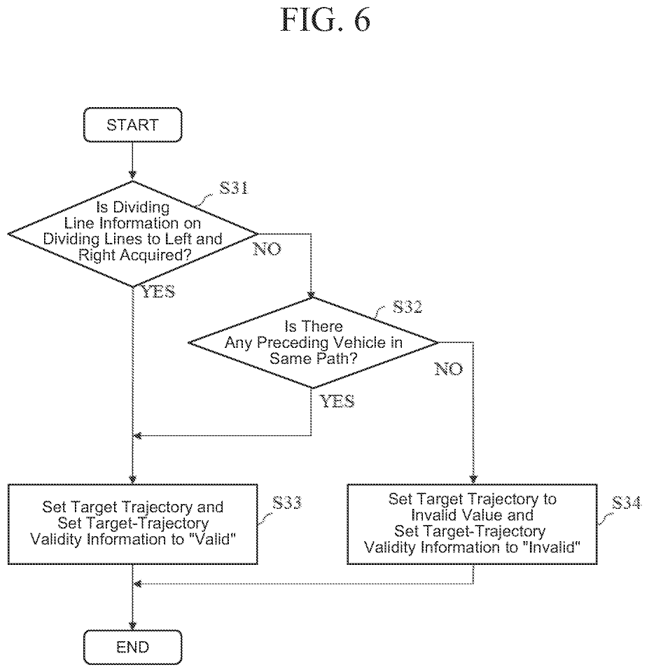

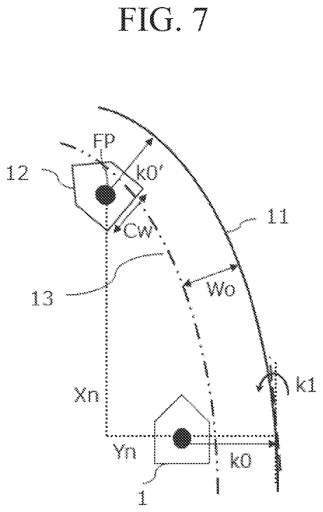

Returning to FIG. 3, in step S3, the target-trajectory setting unit 212 sets a target trajectory on which the vehicle 1 is to travel, on the basis of the dividing line information detected in step S1 and the information on the presence or absence of a preceding vehicle in the same path set in step S2. FIG. 6 is a flowchart illustrating the operation in step S3. In addition, FIG. 7 illustrates an example of the positional relationship of the target trajectory.

In step S31, the target-trajectory setting unit 212 determines whether the dividing line information is acquired for the dividing lines to the left and right of the vehicle 1 or the dividing line information is acquired for only one of the dividing lines to the left and right of the vehicle 1. If it is determined that the dividing line information on the dividing lines to the left and right is acquired, the process proceeds to step S33. If it is determined that only the dividing line information on one of the dividing lines to the left and right is acquired, the process proceeds to step S32. Note that the acquisition of the dividing line information here is not limited to the simple recognition of the dividing line, and may mean a case where the dividing line information is accurately detected in consideration of the reliability thereof. The information on the reliability may be acquired from the camera, or may be separately determined in the system using a known technique or the like (known technique example: WO 2018/131062).

In step S32, the target-trajectory setting unit 212 checks the presence or absence of a preceding vehicle in the same path from the result of step S2, and if there is a preceding vehicle traveling on the same path, the process proceeds to step S33. If there is no preceding vehicle in the same path, the process proceeds to step S34.

If the process proceeds to step S33, it can be determined that the dividing line information acquired in step S1 is set at least in an area having a traveling path. Thus, the target-trajectory setting unit 212 sets the target trajectory using the dividing line information. A line shifted by a predetermined value Wo with respect to the dividing line information is set as the target trajectory. Here, in a case where the dividing line information on the dividing lines to the left and right of the vehicle 1 is acquired, Wo is set in such a manner that a line passing through a midway position between the left and right dividing lines is the target trajectory. In a case where only the dividing line information on one of the dividing lines to the left and right of the vehicle 1 is acquired, Wo is set to ½ of the distance between left and right dividing lines on the basis of the distance between the left and right dividing lines in the period of time during which the dividing line information on the dividing lines to the left and right of the vehicle 1 has been detected in the past. In addition, in a case where there is no period of time during which the dividing lines to the left and right have been detected in the past, Wo is set to a preset fixed value. Note that even in a case where there is a period of time during which the dividing lines to the left and right of the vehicle 1 have been acquired in the past, Wo may be set to the preset fixed value. Furthermore, the target trajectory also has target-trajectory validity information indicating whether information on the target trajectory is valid or invalid, and the target-trajectory validity information is set to “valid” in step S33.

If the process proceeds to step S34, the target-trajectory setting unit 212 sets the target trajectory to an invalid value since the dividing line information acquired in step S1 is set at a position other than the traveling path and there is a possibility of erroneous detection. In addition, the target-trajectory validity information is set to “invalid”.

Returning to FIG. 3, in step S4, the control-amount computation unit 213 computes the control amount of the actuator so as to achieve the tire angle necessary for the vehicle 1 to travel along the target trajectory, on the basis of the target trajectory set in step S3. The control amount is, for example, a current. If the target trajectory is “valid” in step S3, the control amount is computed and output. On the other hand, if the target trajectory is “invalid” in step S3, the control amount is set to 0, and the control to follow the target trajectory is invalidated.

In step S5, the control unit of the actuator 300 controls the actuator 300 on the basis of the control amount that is the result of S4, thereby controlling the electric power steering to move the tire angle in such a manner that the vehicle 1 follows the target trajectory set in S3.

As described above, the target trajectory computation device of the first embodiment includes:
an in-the-same-path determination unit to, on the basis of dividing line information including a position and a shape of at least one of a left dividing line or a right dividing line with respect to a vehicle acquired by a dividing-line-information acquisition unit and preceding vehicle information including a shape and a traveling position of a preceding vehicle traveling ahead of the vehicle acquired by a preceding-vehicle-information acquisition unit, determine presence or absence of a preceding vehicle traveling on the same path as the vehicle, the in-the-same-path determination unit being configured to determine that there is a preceding vehicle traveling on the same path as the vehicle in a case where the preceding vehicle is present within a predetermined range set on the basis of the dividing line information; and
a target-trajectory setting unit to set a target trajectory on which the vehicle is to travel on the basis of the dividing line information and a result of the determination by the in-the-same-path determination unit, the target-trajectory setting unit being configured to, in a case where the dividing line acquisition unit can acquire the dividing line information on only one of the left dividing line and the right dividing line, compute the target trajectory on the basis of the acquired dividing line information on the one dividing line when the in-the-same-path determination unit determines that the preceding vehicle traveling on the same path is present, and omit to compute the target trajectory when the in-the-same-path determination unit determines that the preceding vehicle is not present.

Furthermore, the target trajectory computation method of the first embodiment includes the steps of:
acquiring, by an in-the-same-path determination unit, dividing line information including a position and a shape of at least one of a left dividing line or a right dividing line with respect to a vehicle from a dividing-line-information acquisition unit;
acquiring, by the in-the-same-path determination unit, preceding vehicle information including a shape and a traveling position of a preceding vehicle traveling ahead of the vehicle from a preceding-vehicle-information acquisition unit;
determining, by the in-the-same-path determination unit, presence or absence of a preceding vehicle traveling on the same path as the vehicle on the basis of the dividing line information and the preceding vehicle information, the in-the-same-path determination unit being configured to determine that there is a preceding vehicle traveling on the same path as the vehicle in a case where the preceding vehicle is present within a predetermined range set on the basis of the dividing line information; and
setting, by a target-trajectory computation unit, a target trajectory on which the vehicle is to travel on the basis of the dividing line information and a result of the determination by the in-the-same-path determination unit, the target-trajectory computation unit being configured to, in a case where the dividing line acquisition unit can acquire the dividing line information on only one of the left dividing line and the right dividing line, compute the target trajectory on the basis of the acquired dividing line information on the one dividing line when the in-the-same-path determination unit determines that the preceding vehicle traveling on the same path is present.

According to the target trajectory computation device and the target trajectory computation method according to the first embodiment described above, in a case where only the dividing line information on one of the left and right dividing lines can be acquired, the target trajectory is computed using the information on the preceding vehicle traveling on the same path only in a case where there is a preceding vehicle traveling on the same path. Therefore, even in a case where only the dividing line information on one of the left and right dividing lines can be acquired, it is possible to ensure the correctness of the target trajectory generated from the dividing line information on one dividing line acquired. As a result, even in a case where only one of the left and right dividing lines can be acquired, it is possible to suppress generation of an erroneous target trajectory, erroneous steering control based on the erroneous target trajectory, and the like, and to achieve stable vehicle control along the path. In addition, it is possible to allow control to follow the target trajectory generated from the dividing line information on one dividing line acquired, and thus it is possible to improve the operating time of the steering control. Furthermore, even in a case where the dividing line information has an abnormal value, it is possible to detect the abnormal value and suppress unnecessary control which is due to the abnormal value and which is not along the traveling path.

### Second Embodiment

The target trajectory computation device according to the first embodiment checks the presence or absence of a preceding vehicle in the same path on the basis of the dividing line information acquired by the dividing-line-information acquisition unit 110 and the preceding vehicle position acquired by the preceding-vehicle-position acquisition unit 120, and in a case where there is a preceding vehicle in the same path, even if the dividing line information acquired by the dividing-line-information acquisition unit 110 is only the dividing line information on one of the left and right dividing lines, control is executed using the target trajectory generated on the basis of the dividing line information on one dividing line. On the other hand, a target trajectory computation device according to a second embodiment is configured to determine that the preceding vehicle is traveling on the same path on the basis of the time during which the preceding vehicle is in the same path.

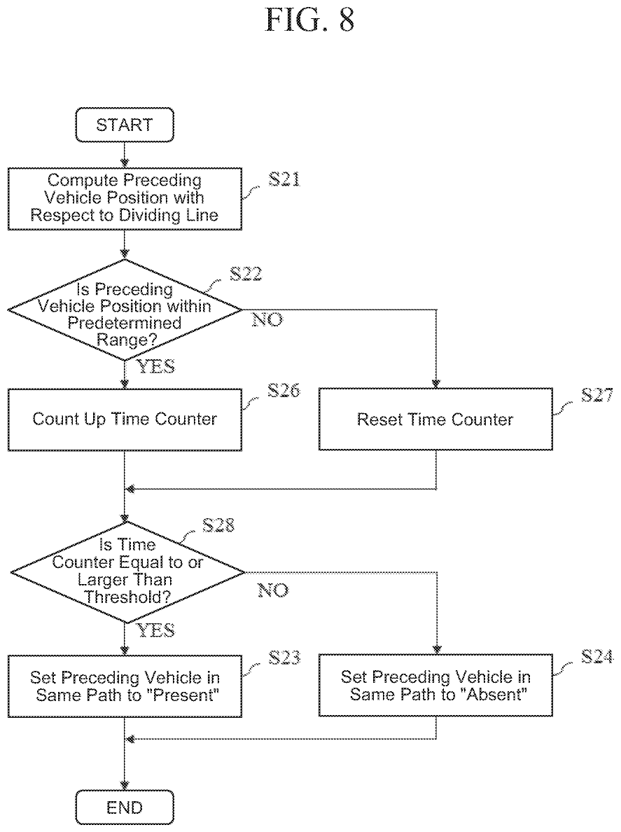

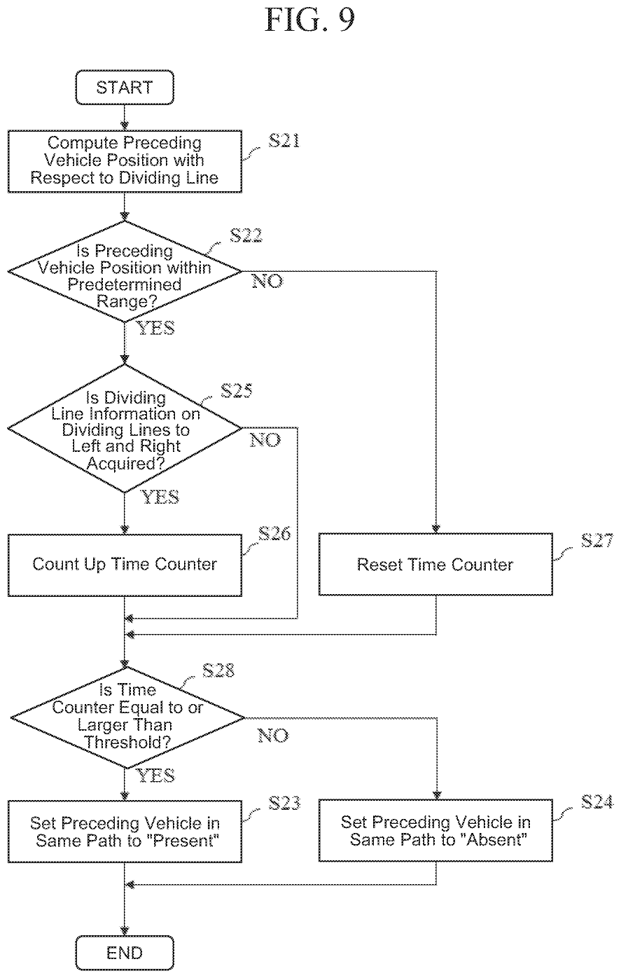

FIG. 8 is a flowchart illustrating details of processing performed by the target trajectory computation device according to the second embodiment. In the case of the target trajectory computation device according to the second embodiment, in the process (FIG. 5) of step S2 in the processing (FIG. 3) performed by the target trajectory computation device according to the first embodiment, steps S26, S27, and S28 are added between step S22 and step S23 or step 24, the process proceeds to S26 if it is determined in step S22 that there is a preceding vehicle in the same path, and the process proceeds to step S27 if it is determined in step S22 that there is no preceding vehicle in the same path. Except for the above, the operation similar to the operation of the vehicle control device according to the first embodiment is performed. Therefore, the processes in steps S26, S27, and S28 will be mainly described below.

The target trajectory computation device of the second embodiment includes a time counter for measuring the time during which the preceding vehicle is within the predetermined range D from the target trajectory, and in step S26, a time counter value Ct is incremented by one by Equation (3).

[Equation 3]

Cₜ=Cₜ₋₁+1 (3)

In step S27, the target trajectory computation device resets the time counter by Equation (4).

[Equation 4]

Cₜ=0 (4)

In step S28, the in-the-same-path determination unit 211 determines whether or not the time counter value Ct calculated in step S26 or step S27 is equal to or larger than a preset threshold Ct_Max. That is, only vehicles traveling on the same path for Ct_Max×computation period (0.01 seconds) or more are extracted, and vehicles that have only temporarily passed ahead of the vehicle 1 are not set as targets for determining the certainty of the dividing line information. If the time counter is equal to or larger than the threshold, the process proceeds to step S23, and if the time counter is less than the threshold, the process proceeds to step S24.

In a case where only one of the left and right dividing lines can be acquired and the dividing line information thereon is erroneous, when there is a preceding vehicle accidentally within a predetermined range set on the basis of the erroneous dividing line, it may be determined that there is a preceding vehicle traveling on the same path, and the target trajectory may be calculated on the basis of the erroneous dividing line information. For example, in a case where the dividing line information is erroneously acquired in a shape largely bent to the right, when there is a preceding vehicle ahead of the vehicle 1 on the adjacent right lane, it can be determined that there is a preceding vehicle traveling on the same path. On the other hand, by putting a time condition in the determination whether there is a preceding vehicle traveling on the same path as in the second embodiment, it can be expected that a preceding vehicle that has been only temporarily present on the same path, an obstacle that has been temporarily erroneously detected by a sensor, or the like is not determined to be a preceding vehicle traveling on the same path.

According to the target trajectory computation device of the second embodiment described above, the in-the-same-path determination unit is configured to determine that there is a preceding vehicle traveling on the same path as the vehicle in a case where a state where the preceding vehicle is present within the predetermined range set on the basis of the dividing line information continues for a predetermined period of time or longer. Therefore, it is possible to more accurately determine whether the preceding vehicle is traveling on the same path as the vehicle. According to such a configuration, in a case where one of the dividing lines cannot be acquired and the information thereon is temporarily erroneous, it is possible to suppress determining that the preceding vehicle is in the same path on the basis of the erroneous dividing line information and to suppress the computation of the erroneous target trajectory. Therefore, it is possible to execute stable control.

### Third Embodiment

A target trajectory computation device according to a third embodiment is obtained by partially changing the determination flow of the in-the-same-path determination unit in the target trajectory computation device according to the second embodiment. Specifically, the in-the-same-path determination unit is configured to determine that there is a preceding vehicle in the same path in a case where a state where dividing lines to both the left and right of a vehicle can be acquired and a preceding vehicle is present within a predetermined range set on the basis of dividing line information continues for a predetermined period of time or longer.

FIG. 8 is a flowchart illustrating details of processing performed by the target trajectory computation device according to the third embodiment. In the case of the target trajectory computation device according to the third embodiment, in the process (FIG. 8) of step S2 performed by the target trajectory computation device according to the second embodiment, step S25 is added between step S22 and step S26, and the process proceeds to S25 if it is determined in step S22 that there is a preceding vehicle in the same path. Except for the above, the operation similar to the operation of the vehicle control device according to the second embodiment is performed. Therefore, the process in step S25 will be mainly described below.

In step S25, the in-the-same-path determination unit 211 determines whether the dividing lines to the left and right of the vehicle 1 are acquired or only one of the dividing lines to the left and right of the vehicle 1 is acquired. If it is determined that both the left and right dividing lines are acquired, the process proceeds to step S26, and the time counter value Ct is incremented by one. If it is determined that only one of the left and right dividing lines is acquired, step S26 is skipped and the process proceeds to step S28.

By inserting step S25, only the case where the dividing lines to the left and right of the vehicle are acquired and the preceding vehicle is present within the predetermined range set on the basis of the dividing line information is counted, so that the reliability of the determination that the preceding vehicle is present in the same path can be further increased. Furthermore, since the reliability of the determination that the preceding vehicle is in the same path is increased, even in a case where one of the dividing lines cannot be acquired thereafter, it is possible to continue the subsequent processing on the basis of the information on the preceding vehicle that has been determined to be the preceding vehicle in the same path so far. Therefore, it is possible to keep the reliability of the subsequent processing high.

According to the target trajectory computation device according to the third embodiment described above, the in-the-same-path determination unit is configured to determine that there is a preceding vehicle in the same path in a case where a state where both the left dividing line and the right dividing line with respect to the vehicle can be acquired and the preceding vehicle is present within the predetermined range set on the basis of the dividing line information continues for the predetermined period of time or longer. Therefore, it is possible to more accurately determine whether the preceding vehicle is traveling on the same path as the vehicle.

### Modification

In the above description, the device using the target trajectory for the lane keeping system has been described, but it is not limited thereto, and the target trajectory may be used for a lane departure warning device, an autonomous driving device, or the like. The technique described in the embodiments can be applied to the use of the dividing line information and the traveling path.

### Other Modifications

The vehicle control device described above can also be applied to a vehicle control system that generates a target trajectory by combining an artificial satellite and map information, and a vehicle control system that generates a target trajectory by appropriately combining a navigation device, a communication terminal including a mobile terminal such as a mobile phone, a smartphone, or a tablet, an application function installed in these communication terminals, and a server. In this case, the functions and components of the vehicle control device described above may be arranged in a distributed manner in the devices constituting the system, or may be arranged in a concentrated manner in one of the devices.

Note that, in the present disclosure, the embodiments and modifications can be freely combined, or the embodiments and modifications can be appropriately modified or omitted within the scope of the invention.

Although the present disclosure has been described in detail, the above description is illustrative in all aspects, and the present disclosure is not limited thereto. It is understood that countless modifications not illustrated are assumed without departing from the scope of the present disclosure.

### REFERENCE SIGNS LIST

1: vehicle, 2: steering wheel, 3: steering shaft, 4: steering unit, 5: electric-power steering unit, 6: powertrain unit, 7: brake unit, 8: yaw rate sensor, 9: vehicle speed sensor, 10: front camera, 11: dividing line, 12: preceding vehicle, 110: dividing-line-information acquisition unit, 120: preceding-vehicle-information acquisition unit, 200: vehicle control device, 210: target trajectory computation device, 211: in-the-same-path determination unit, 212: target-trajectory setting unit, 220: control-amount computation unit, 300: actuator, 310: electric-power steering controller, 311: powertrain controller, 312: brake controller

1. A target trajectory computation device comprising:
processing circuitry
to, on a basis of dividing line information including a position and a shape of at least one of a left dividing line or a right dividing line with respect to a vehicle and preceding vehicle information including a shape and a traveling position of a preceding vehicle traveling ahead of the vehicle, determine presence or absence of a preceding vehicle traveling on a same path as the vehicle;
to determine that there is a preceding vehicle traveling on the same path as the vehicle in a case where the preceding vehicle is present within a predetermined range;
to set a target trajectory on which the vehicle is to travel on a basis of the dividing line information and a result of the determination; and
to, in a case where the dividing line information on only one of the left dividing line and the right dividing line can be acquired, compute the target trajectory on a basis of the acquired dividing line information on the one dividing line when it is determined that the preceding vehicle traveling on the same path is present, and omit to compute the target trajectory when it is determined that the preceding vehicle is not present.

2. The target trajectory computation device according to claim 1, wherein in a case where a state where the preceding vehicle is present within the predetermined range continues for a predetermined period of time or longer, the processing circuitry determines that there is a preceding vehicle traveling on the same path as the vehicle.

3. The target trajectory computation device according to claim 1, wherein in a case where a state where both the left dividing line and the right dividing line with respect to the vehicle can be acquired and the preceding vehicle is present within the predetermined range continues for a predetermined period of time or longer, the processing circuitry determines that there is a preceding vehicle traveling on the same path as the vehicle.

4. The target trajectory computation device according to claim 1, wherein the predetermined range changes depending on at least one of the dividing line information, the shape, a speed, or the traveling position of the preceding vehicle.

5. A vehicle control device comprising:
the target trajectory computation device according to claim 1; and
processing circuitry to compute a control amount of an actuator for controlling a vehicle in such a manner as to follow a target trajectory calculated by the target trajectory computation device.

6. A target trajectory computation method comprising:
acquiring dividing line information including a position and a shape of at least one of a left dividing line or a right dividing line with respect to a vehicle;
acquiring preceding vehicle information including a shape and a traveling position of a preceding vehicle traveling ahead of the vehicle;
determining presence or absence of a preceding vehicle traveling on a same path as the vehicle on a basis of the dividing line information and the preceding vehicle information;
determining that there is a preceding vehicle traveling on the same path as the vehicle in a case where the preceding vehicle is present within a predetermined range;
setting a target trajectory on which the vehicle is to travel on a basis of the dividing line information and a result of the determination; and
in a case where the dividing line information on only one of the left dividing line and the right dividing line can be acquired, computing the target trajectory on a basis of the acquired dividing line information on the one dividing line when it is determined that the preceding vehicle traveling on the same path is present.
